(19) United States
(12) Patent Application Publication
(10) Pub. No.: US 2020/0398691 A1
(43) Pub. Date: Dec. 24, 2020

(54) CHARGING DEVICE AND CHARGING/DISCHARGING DEVICE

(71) Applicant: Mitsubishi Electric Corporation, Tokyo (JP)

(72) Inventor: Yutaka KUBOYAMA, Tokyo (JP)

(73) Assignee: Mitsubishi Electric Corporation, Tokyo (JP)

(21) Appl. No.: 16/618,288

(22) PCT Filed: Aug. 21, 2018
(86) PCT No.: PCT/JP2018/030832

§ 371 Date: Nov. 29, 2019

(51) Int. Cl. B60L 53/60; B60L 53/16; B60L 53/18; B60L 53/30; H02J 7/00; H01M 10/46; H01M 10/42

(52) U.S. Cl. CPC B60L 53/60; B60L 53/16; B60L 53/18; B60L 53/305; H01M 2220/20; H02J 7/00032; H01M 10/46; H01M 10/4257; H01M 2010/4278; H02J 7/0045

(57) ABSTRACT

A charging device is a charging device that charges a storage battery of an electromotive vehicle, and includes a first relay that generates a communication start signal for starting communication between the charging device and the electromotive vehicle; a cable that electrically connects the charging device and the electromotive vehicle, the cable including a connector at one end thereof; and a controller that controls the first relay to start the communication before or when the connector is inserted into a plug provided on the electromotive vehicle.

### FIELD

The present invention relates to a charging device and a charging/discharging device for an electromotive vehicle.

### BACKGROUND

In recent years, with the increase of electromotive vehicles such as electric vehicles (EVs) and plug-in hybrid vehicles (PHVs), charging infrastructures are spreading. As a billing method for a charging device for electromotive vehicles, Plug and Charge (PnC) has been proposed in which charging is automatically started by simply connecting a connector of the charging device to a vehicle.

As a Vehicle to Home (V2H) system in which storage batteries of electromotive vehicles are used for storing energy to adjust power to be sold and bought at home and a Vehicle to Grid (V2G) system in which storage batteries of electromotive vehicles are used for a virtual power plant (VPP) to adjust supply and demand balance of commercial power, a charging/discharging device for electromotive vehicles is employed. In order to manage the quantity of available storage batteries, there is a demand for means for confirming a connection state between a charging device or a charging/discharging device and an electromotive vehicle.

Regarding the electromotive vehicles and the charging devices, configurations and operations thereof are defined by guidelines, and for example, it is defined that each of the electromotive vehicles and the charging devices includes a connector connection confirmation unit, a charge start/stop unit, and a communication unit. In addition, it is specified such that when a connector of a charging device is connected to an electromotive vehicle and a charge start/stop relay of the charging device is turned ON, communication is started between the electromotive vehicle and the charging device. As for guidelines for electromotive vehicles and charging/discharging devices, the guidelines for electromotive vehicles and charging devices are applied thereto, and configurations and operations of the electromotive vehicles and the charging/discharging devices are similar to the configurations and operations of the electromotive vehicles and the charging devices.

Patent Literature 1 proposes a connector connection confirmation unit that detects a connection state between a charging instrument and a vehicle using a connector connection confirmation line between the vehicle and the charging instrument.

### CITATION LIST

### Patent Literature

Patent Literature 1: Japanese Patent Application Laid-open No. 2014-217272

### SUMMARY

### Technical Problem

However, for the connector connection confirmation unit disclosed in Patent Literature 1, it is necessary that a voltage be applied from the vehicle to the connector connection confirmation line, and the connector connection confirmation unit cannot be applied to a vehicle that does not apply a voltage to the connector connection confirmation line due to fear of, for example, a short circuit of a vehicle power supply, corrosion of an electrode, or discharge of an auxiliary battery, which is a problem.

The present invention has been made in view of the above, and an object thereof is to provide a charging device that can detect a connection state with an electromotive vehicle that does not apply a voltage to a connector connection confirmation line.

### Solution to Problem

To solve the problem and achieve the object described above, the present invention is a charging device that charges a storage battery of an electromotive vehicle, and includes: a first relay that generates a communication start signal for starting communication between the charging device and the electromotive vehicle; a cable that electrically connects the charging device and the electromotive vehicle, the cable including a connector at one end thereof; and a controller that controls the first relay to start the communication before or when the connector is inserted into a plug provided on the electromotive vehicle.

### Advantageous Effects of Invention

The charging device according to the present invention achieves an effect of detecting a connection state with an electromotive vehicle that does not apply a voltage to a connector connection confirmation line.

### BRIEF DESCRIPTION OF DRAWINGS

FIG. 1 is a first diagram illustrating a state where an electromotive vehicle is connected to a charging device according to a first embodiment.

FIG. 2 is a second diagram illustrating the state where the electromotive vehicle is connected to the charging device according to the first embodiment.

FIG. 3 is a flowchart illustrating a sequence of conventional operations performed by a user, the charging device, and the electromotive vehicle.

FIG. 4 is a flowchart illustrating a sequence of operations in the first embodiment performed by the user, the charging device, and the electromotive vehicle.

FIG. 5 is a diagram for explaining an operation related to an operation of detecting a connection state between the charging device according to the first embodiment and the electromotive vehicle performed by a controller of the charging device.

FIG. 6 is a view illustrating configurations of a connector and a claw included in a charging device according to a second embodiment.

FIG. 7 is a diagram for explaining an operation related to an operation of detecting a connection state between the charging device according to the second embodiment and the electromotive vehicle performed by the controller of the charging device.

FIG. 8 is a flowchart illustrating a sequence of operations in a third embodiment performed by the user, a charging device, and the electromotive vehicle.

FIG. 9 is a diagram for explaining an operation related to an operation of detecting a connection state between the charging device according to the third embodiment and the electromotive vehicle performed by the controller of the charging device.

FIG. 10 is a diagram illustrating a processing circuit when at least a part of components constituting a first relay and the controller included in the charging device according to the first embodiment is realized by the processing circuit.

FIG. 11 is a diagram illustrating a processor when at least a part of functions of the first relay and the controller included in the charging device according to the first embodiment is realized by the processor.

### DESCRIPTION OF EMBODIMENTS

Hereinafter, a charging device and a charging/discharging device according to each embodiment of the present invention will be described in detail with reference to the drawings. The present invention is not limited to the embodiments.

### First Embodiment

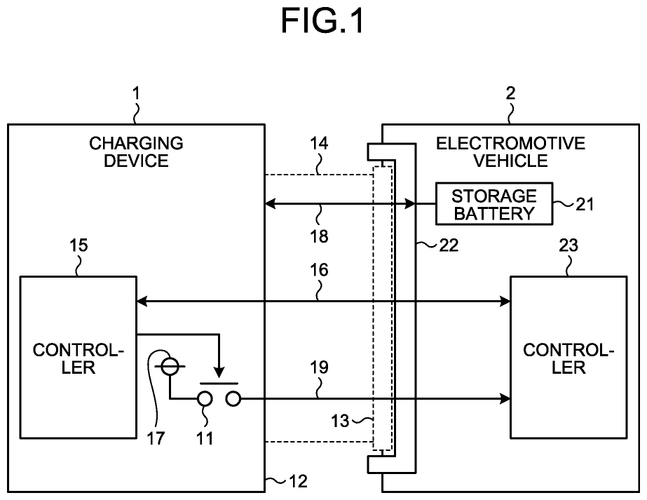

FIG. 1 is a first diagram illustrating a state where an electromotive vehicle 2 is connected to a charging device 1 according to a first embodiment. The electromotive vehicle 2 includes a storage battery 21. The charging device 1 is a device that charges the storage battery 21 of the electromotive vehicle 2. The charging device 1 includes a first relay 11 that generates a communication start signal for starting communication between the charging device 1 and the electromotive vehicle 2.

The charging device 1 further includes a cable 14 including a connector 13 at one end thereof. The other end of the cable 14 is connected to a housing 12 of the charging device 1. The cable 14 has a function of electrically connecting the charging device 1 and the electromotive vehicle 2. A plug 22 is provided on the electromotive vehicle 2. The connector 13 is connected to the plug 22. The charging device 1 and the electromotive vehicle 2 are connected via the cable 14 and the plug 22.

The charging device 1 further includes a controller 15 that controls the first relay 11 before or when the connector 13 is inserted into the plug 22 provided on the electromotive vehicle 2 to start communication between the charging device 1 and the electromotive vehicle 2. The controller 15 detects a connection state between the charging device 1 and the electromotive vehicle 2 by starting the communication. After starting the communication, the controller 15 causes the storage battery 21 of the electromotive vehicle 2 to start charging. The controller 15 has a function of periodically controlling the first relay 11 to detect a state where the charging device 1 and the electromotive vehicle 2 are not connected. The charging device 1 further includes a power supply 17.

The electromotive vehicle 2 includes a controller 23 that controls an operation related to charging of the electromotive vehicle 2. The controller 23 communicates with the controller 15 of the charging device 1 via a communication line 16 included in the cable 14, and inputs and outputs signals using a signal line other than the communication line 16 included in the cable 14, thereby managing the operation related to charging of the electromotive vehicle 2.

The controller 15 of the charging device 1 controls an operation related to charging of the charging device 1. The controller 15 communicates with the controller 23 of the electromotive vehicle 2 via the communication line 16 included in the cable 14, and inputs and outputs signals using a signal line other than the communication line 16 included in the cable 14, thereby managing the operation related to charging of the charging device 1. The cable 14 includes the communication line 16, and includes a power line 18, and a charge start/stop line 19.

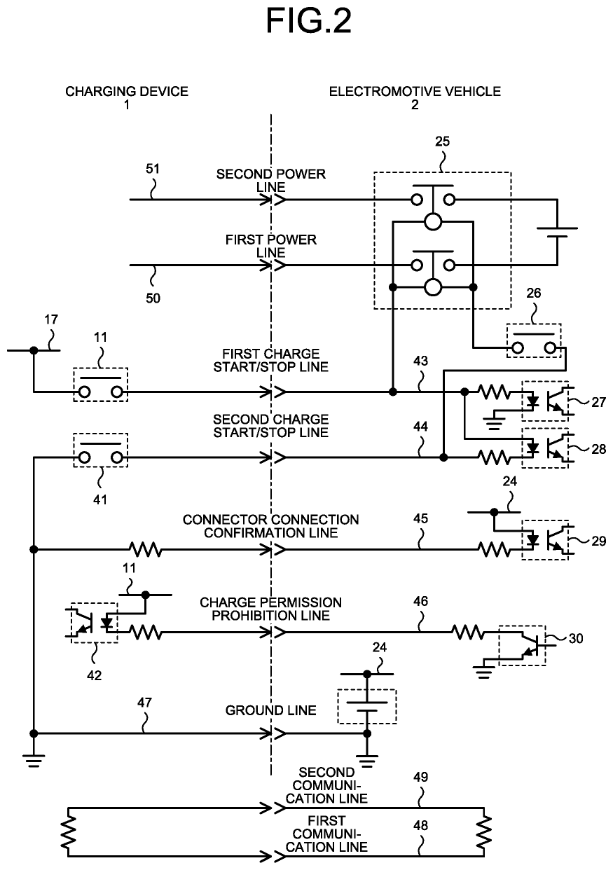

FIG. 2 is a second diagram illustrating the state where the electromotive vehicle 2 is connected to the charging device 1 according to the first embodiment. The electromotive vehicle 2 includes a power supply 24, a vehicle contactor 25, a vehicle contactor drive relay 26, a first relay detector 27, a second relay detector 28, a connection detector 29, and a charge/discharge permission prohibition output unit 30.

The charging device 1 includes the first relay 11 and the power supply 17, and includes a second relay 41 and a charge permission prohibition input unit 42. The charging device 1 and the electromotive vehicle 2 are connected via a first charge start/stop line 43, a second charge start/stop line 44, a connector connection confirmation line 45, a charge permission prohibition line 46, a ground line 47, a first communication line 48, a second communication line 49, a first power line 50, and a second power line 51.

The first charge start/stop line 43, the second charge start/stop line 44, the connector connection confirmation line 45, the charge permission prohibition line 46, the ground line 47, the first communication line 48, the second communication line 49, the first power line 50, and the second power line 51 are included in the cable 14. The first charge start/stop line 43 corresponds to the charge start/stop line 19 in FIG. 1. The first communication line 48 and the second communication line 49 correspond to the communication line 16 in FIG. 1. The first power line 50 and the second power line 51 correspond to the power line 18 in FIG. 1.

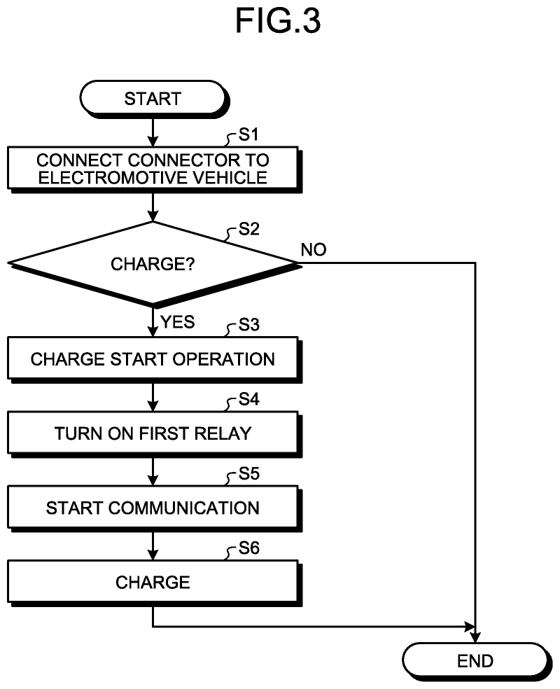

FIG. 3 is a flowchart illustrating a sequence of conventional operations performed by a user, the charging device 1, and the electromotive vehicle 2. The conventional operations performed by the user, the charging device 1, and the electromotive vehicle 2 will be described with reference to FIGS. 1, 2, and 3.

First, the user connects the connector 13 included in the cable 14 of the charging device 1 to the plug 22 of the electromotive vehicle 2 (S1). The user determines whether the user desires to charge the storage battery 21 (S2). When the user determines that the user desires to charge the storage battery 21 (Yes in S2), the user performs a charge start operation, for example, in accordance with a user interface provided in the charging device 1 or a billing system (S3).

Upon receiving the charge start operation by the user, the controller 15 of the charging device 1 turns ON the first relay 11 (S4). The first relay detector 27 of the electromotive vehicle 2 detects the first relay 11 being ON. Next, the controller 23 of the electromotive vehicle 2 starts communication with the controller 15 via the first communication line 48 and the second communication line 49 (S5). After the start of the communication between the controller 23 and the controller 15, the controller 15 starts charging the storage battery 21 (S6). When the user does not determine that the user desires to charge the storage battery 21 (No in S2), the operations of the user, the charging device 1, and the electromotive vehicle 2 end.

In the conventional operations described with reference to FIG. 3, the user needs to perform two operations in Step S1 and Step S3. The number of operations by the user is larger in the conventional operations than in PnC in which charging of the storage battery 21 is started by the user simply connecting the connector 13 of the charging device 1 to the plug 22 of the electromotive vehicle 2. In addition, in the conventional operations, the connection state between the charging device 1 and the electromotive vehicle 2 is not detected when the user simply connects the connector 13 of the charging device 1 to the plug 22 of the electromotive vehicle 2. For this reason, the conventional operations described with reference to FIG. 3 have a problem of impairing user convenience.

According to the technique described in Patent Literature 1, the charging device detects that the user connects the connector 13 to the plug 22, and thereby the user's operations in Step S1 and Step S3 can be skipped. However, it is necessary to add, to the charging device, a connection detector that detects that the connector 13 is connected to the plug 22. Along with the above, there arises a problem that the cost of the charging device increases. In addition, because the connection detector is a connector connection confirmation unit that uses the connector connection confirmation line 45, the user's operations in Step S1 and Step S3 cannot be skipped for an electromotive vehicle that does not apply a voltage to the connector connection confirmation line 45, and the problem of impairing user convenience is not solved.

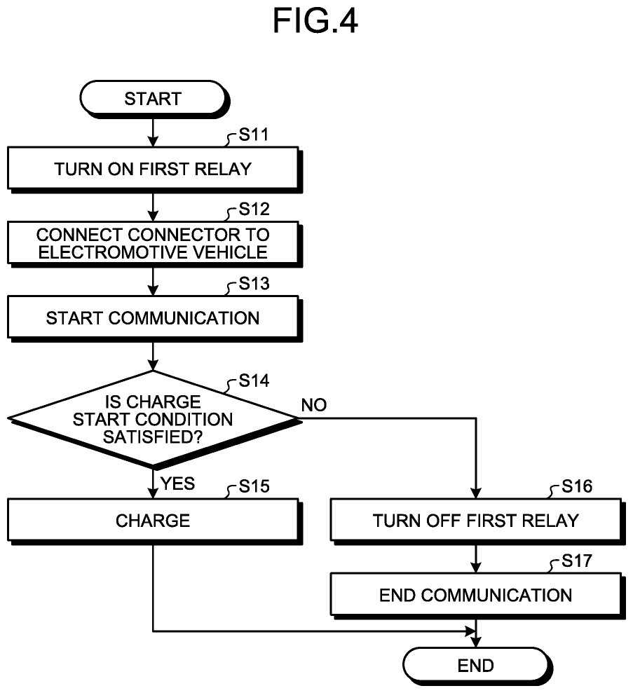

FIG. 4 is a flowchart illustrating a sequence of operations in the first embodiment performed by the user, the charging device 1, and the electromotive vehicle 2. The operations in the first embodiment performed by the user, the charging device 1, and the electromotive vehicle 2 will be described with reference to FIGS. 1, 2, and 4.

First, the controller 15 of the charging device 1 turns ON the first relay 11 (S11). Next, the user connects the connector 13 included in the cable 14 of the charging device 1 to the plug 22 of the electromotive vehicle 2 (S12).

The first relay detector 27 of the electromotive vehicle 2 detects the first relay 11 being ON, and the controller 23 of the electromotive vehicle 2 starts communication with the controller 15 of the charging device 1 via the first communication line 48 and the second communication line 49 (S13).

The controller 15 of the charging device 1 determines on the basis of information received from the electromotive vehicle 2 whether a charge start condition is satisfied (S14). A case where the charge start condition is satisfied is, for example, a case where the billing system permits charging, or a case where charging is permitted by a charge start operation performed by the user in advance. When the controller 15 determines that the charge start condition is satisfied (Yes in S14), the controller 15 starts charging the storage battery 21 (S15).

When the controller 15 of the charging device 1 determines that the charge start condition is not satisfied (No in S14), the controller 15 turns OFF the first relay 11 (S16). The first relay detector 27 of the electromotive vehicle 2 detects the first relay 11 being OFF, and then the controller 23 of the electromotive vehicle 2 ends the communication with the controller 15 (S17).

In the operations in the first embodiment described with reference to FIG. 4, the number of operations by the user is only one, the operation being performed in Step S12, and the PnC is realized in which charging is started by the user simply connecting the connector 13 of the charging device 1 to the plug 22 of the electromotive vehicle 2. In addition, since the controller 23 of the electromotive vehicle 2 starts communication with the controller 15 of the charging device 1 when the user simply connects the connector 13 to the plug 22, the controller 15 can detect the connection state between the charging device 1 and the electromotive vehicle 2, which makes it possible to notify the user of information indicating the connection state.

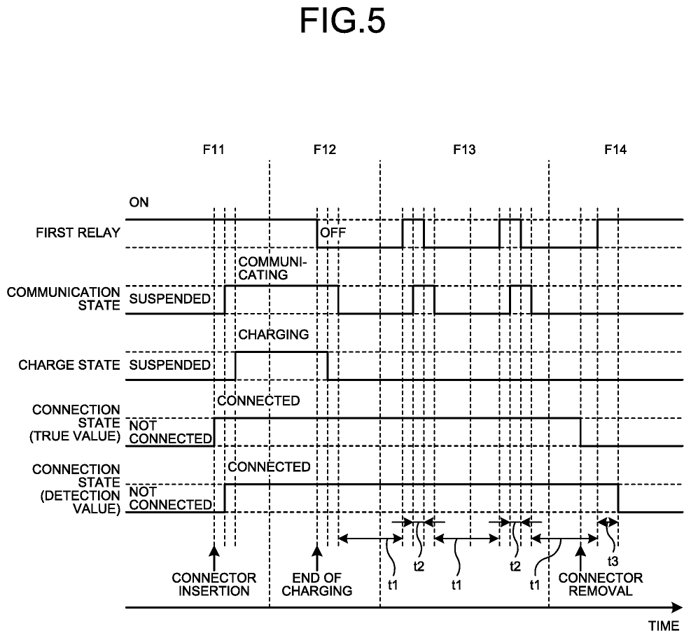

FIG. 5 is a diagram for explaining an operation related to an operation of detecting a connection state between the charging device 1 according to the first embodiment and the electromotive vehicle 2 performed by the controller 15 of the charging device 1. The operation related to the operation of detecting the connection state between the charging device 1 and the electromotive vehicle 2 performed by the controller 15 will be described with reference to FIGS. 1, 2, 4, and 5. “COMMUNICATION STATE” in FIG. 5 means a communication state between the charging device 1 and the electromotive vehicle 2. “CHARGE STATE” in FIG. 5 means a charge state of the storage battery 21. “CONNECTION STATE (TRUE VALUE)” in FIG. 5 means an actual connection state between the charging device 1 and the electromotive vehicle 2. “CONNECTION STATE (DETECTION VALUE)” in FIG. 5 means a detection result of the connection state between the charging device 1 and the electromotive vehicle 2.

When the connector 13 of the charging device 1 is connected to the plug 22 of the electromotive vehicle 2, the controller 15 of the charging device 1 communicates with the controller 23 of the electromotive vehicle 2 to thereby detect the connection state between the charging device 1 and the electromotive vehicle 2, and starts charging the storage battery 21 (Phase F11). In FIG. 5, the connection of the connector 13 to the plug 22 is described as “CONNECTOR INSERTION”.

When the charging ends, the controller 15 of the charging device 1 turns OFF the first relay 11 and ends the communication with the electromotive vehicle 2 (Phase F12). At that time, the charging device 1 maintains the connection state between the charging device 1 and the electromotive vehicle 2.

The controller 15 of the charging device 1 periodically repeats an operation in which when ending the communication with the electromotive vehicle 2, the controller 15 of the charging device 1 turns ON the first relay 11 after the elapse of a predetermined time t1, and when confirming that the communication with the electromotive vehicle 2 can be performed, the controller 15 of the charging device 1 turns OFF the first relay 11 after the elapse of a predetermined time t2 (Phase F13). At that time, the charging device 1 maintains the connection state between the charging device 1 and the electromotive vehicle 2. For example, when it is impossible to confirm a response of communication after the start of the communication to proceed a sequence of operations, timeout may occur to cause abnormal stop. Therefore, the predetermined time t2 is set so as not to cause timeout.

After the connector 13 of the charging device 1 is removed from the plug 22 of the electromotive vehicle 2, the controller 15 of the charging device 1 turns ON the first relay 11, and when confirming that the communication with the electromotive vehicle 2 is not performed, the controller 15 detects that the charging device 1 and the electromotive vehicle 2 are not connected after the elapse of a predetermined time t3 (Phase F14).

As described above, the charging device 1 according to the first embodiment can detect the connection state between the charging device 1 and the electromotive vehicle 2 even for the electromotive vehicle 2 that does not apply a voltage to the connector connection confirmation line 45. In addition, the charging device 1 can start charging the storage battery 21 when the connector 13 of the charging device 1 is connected to the electromotive vehicle 2.

Because the charging device 1 according to the first embodiment uses the configurations of the existing charging device and the existing electromotive vehicle, an increase in cost of the charging device 1 is suppressed.

### Second Embodiment

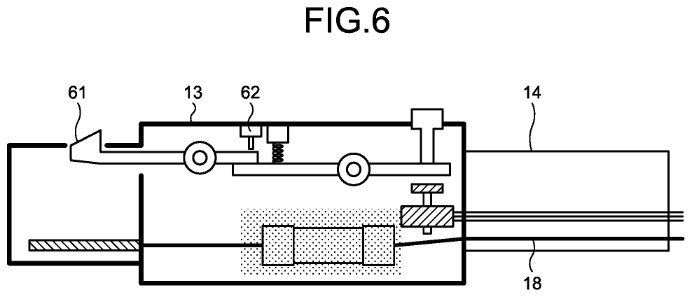

A charging device according to a second embodiment includes all the components included in the charging device 1 according to the first embodiment, and includes components that are not included in the charging device 1. FIG. 6 is a view illustrating configurations of the connector 13 and a claw 61 included in the charging device according to the second embodiment. The charging device according to the second embodiment includes the claw 61 that fixes the connector 13 and the plug 22 when the connector 13 is fitted to the plug 22 of the electromotive vehicle 2. Specifically, the claw 61 is attached to the connector 13 and can be fitted to the plug 22. The charging device according to the second embodiment further includes a claw state detector 62 that detects a latch state of the claw 61.

The claw state detector 62 is also mounted on an existing connector, and detects a state where the claw 61 is raised and a state where the claw 61 is lowered. The state where the claw 61 is raised is the latched state, and the state where the claw 61 is lowered is an unlatched state. The claw 61 enters the unlatched state temporarily when the connector 13 is inserted into the plug 22 of the electromotive vehicle 2, and returns to the latched state when the connector 13 has been correctly inserted into the plug 22. The controller 15 controls the first relay 11 on the basis of a detection result obtained by the claw state detector 62.

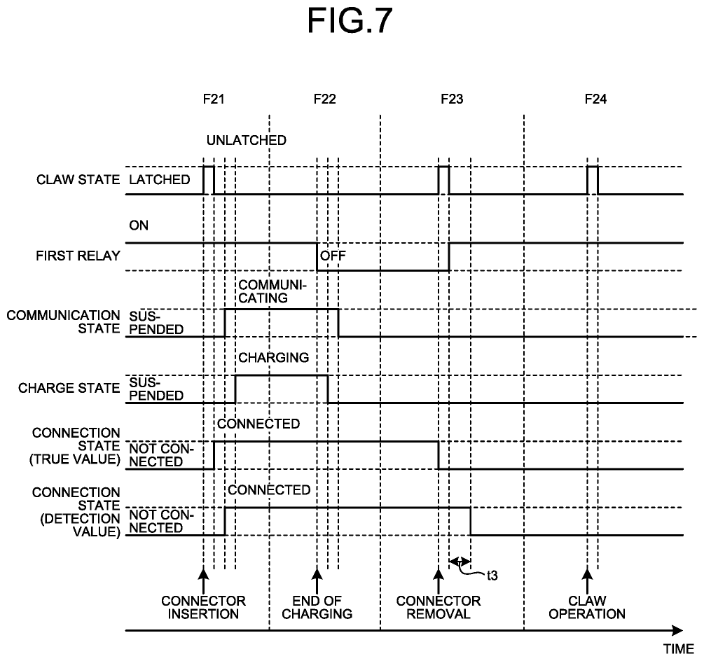

FIG. 7 is a diagram for explaining an operation related to an operation of detecting a connection state between the charging device according to the second embodiment and the electromotive vehicle 2 performed by the controller 15 of the charging device. The operation related to the operation of detecting the connection state between the charging device and the electromotive vehicle 2 performed by the controller 15 of the second embodiment will be described with reference to FIGS. 1, 2, 4, 6, and 7. In FIG. 7, terms included in FIG. 5 used in the first embodiment are used.

When the connector 13 of the charging device according to the second embodiment is connected to the plug 22 of the electromotive vehicle 2, the controller 15 of the charging device communicates with the controller 23 of the electromotive vehicle 2 to thereby detect the connection state between the charging device and the electromotive vehicle 2, and starts charging the storage battery 21 (Phase F21).

When the charging ends, the controller 15 of the charging device according to the second embodiment turns OFF the first relay 11 and ends the communication with the electromotive vehicle 2 (Phase F22). At that time, the charging device maintains the connection state between the charging device and the electromotive vehicle 2.

When the connector 13 of the charging device according to the second embodiment is removed from the plug 22 of the electromotive vehicle 2, the controller 15 of the charging device detects that the claw 61 has entered the unlatched state. The controller 15 turns ON the first relay 11, and when confirming that the communication with the electromotive vehicle 2 is not performed, the controller 15 detects that the charging device and the electromotive vehicle 2 are not connected after the elapse of the predetermined time t3 (Phase F23).

Also in a case where the claw 61 is operated to enter the unlatched state other than a case where the connector 13 of the charging device according to the second embodiment is connected to the plug 22 of the electromotive vehicle 2, the charging device maintains the state where the first relay 11 is being ON (Phase F24). At that time, the charging device maintains the connection state between the charging device and the electromotive vehicle 2.

As described above, the charging device according to the second embodiment can detect the connection state between the charging device and the electromotive vehicle 2 even for the electromotive vehicle 2 that does not apply a voltage to the connector connection confirmation line 45. In addition, the charging device can start charging the storage battery 21 when the connector 13 of the charging device is connected to the electromotive vehicle 2.

Because the opening and closing frequency of the first relay 11 in the charging device according to the second embodiment is less than the opening and closing frequency in the case of the first embodiment, the lifetime of the charging device according to the second embodiment is longer than the lifetime of the charging device 1 according to the first embodiment.

### Third Embodiment

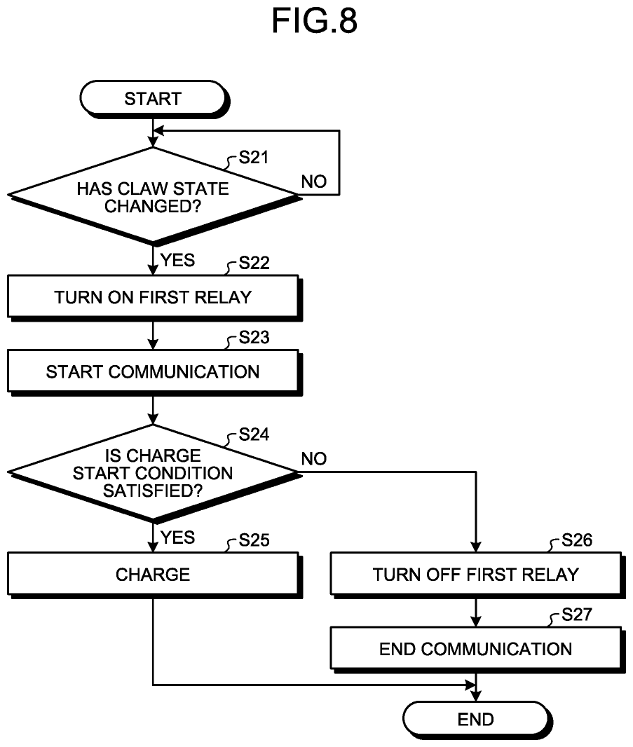

A charging device according to a third embodiment includes all the components included in the charging device according to the second embodiment. FIG. 8 is a flowchart illustrating a sequence of operations in the third embodiment performed by the user, the charging device, and the electromotive vehicle 2. The operations in the third embodiment performed by the user, the charging device, and the electromotive vehicle 2 will be described with reference to FIGS. 1, 2, 4, 6, and 8.

The controller 15 of the charging device according to the third embodiment determines whether the claw 61 of the charging device has changed from the unlatched state to the latched state (S21). In Step S21 of FIG. 8, determination whether the claw 61 has changed from the unlatched state to the latched state is expressed by the phrase “HAS CLAW STATE CHANGED?”. When the controller 15 determines that the claw 61 has changed from the unlatched state to the latched state (Yes in S21), the controller 15 turns ON the first relay 11 (S22). A case where the claw 61 has changed from the unlatched state to the latched state is a case where the connector 13 included in the cable 14 of the charging device is connected to the plug 22 of the electromotive vehicle 2. When the controller 15 determines that the claw 61 does not change from the unlatched state to the latched state (No in S21), the controller 15 performs the operation in Step S21 again.

Next, the first relay detector 27 of the electromotive vehicle 2 detects the first relay 11 being ON, and the controller 23 of the electromotive vehicle 2 starts communication with the controller 15 of the charging device via the first communication line 48 and the second communication line 49 (S23).

The controller 15 determines on the basis of the information received from electromotive vehicle 2 whether a charge start condition is satisfied (S24). A case where the charge start condition is satisfied is, for example, a case where the billing system permits charging, or a case where charging is permitted by a charge start operation performed by the user in advance. When the controller 15 determines that the charge start condition is satisfied (Yes in S24), the controller 15 starts charging the storage battery 21 (S25).

When the controller 15 determines that the charge start condition is not satisfied (No in S24), the controller 15 turns OFF the first relay 11 (S26). The first relay detector 27 of the electromotive vehicle 2 detects the first relay 11 being OFF, and then the controller 23 of the electromotive vehicle 2 ends the communication with the controller 15 (S27).

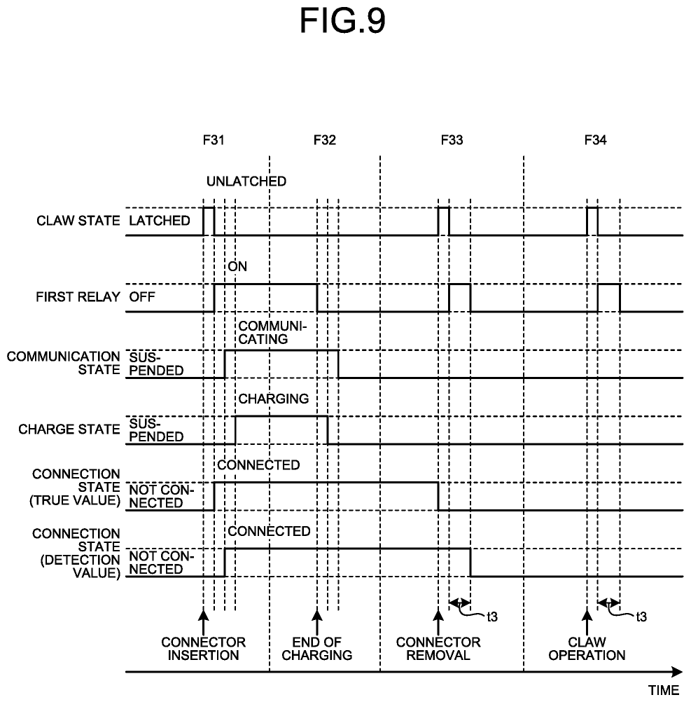

FIG. 9 is a diagram for explaining an operation related to an operation of detecting a connection state between the charging device according to the third embodiment and the electromotive vehicle 2 performed by the controller 15 of the charging device. The operation related to the operation of detecting the connection state between the charging device and the electromotive vehicle 2 performed by the controller 15 of the third embodiment will be described with reference to FIGS. 1, 2, 6, 8, and 9. In FIG. 9, terms included in FIG. 5 used in the first embodiment are used.

When the connector 13 of the charging device according to the third embodiment is connected to the plug 22 of the electromotive vehicle 2, the charging device turns ON the first relay 11 and communicates with the controller 23 of the electromotive vehicle 2 to thereby detect the connection state between the charging device and the electromotive vehicle 2, and starts charging the storage battery 21 (Phase F31).

When the charging ends, the controller 15 of the charging device according to the third embodiment turns OFF the first relay 11 and ends the communication with the electromotive vehicle 2 (Phase F32). At that time, the charging device maintains the connection state between the charging device and the electromotive vehicle 2.

When the connector 13 of the charging device according to the third embodiment is removed from the plug 22 of the electromotive vehicle 2, the controller 15 of the charging device detects that the claw 61 has entered the unlatched state, and turns ON the first relay 11. When confirming that the communication with the electromotive vehicle 2 is not performed, the controller 15 turns OFF the first relay 11 after the elapse of the predetermined time t3 and detects that the charging device and the electromotive vehicle 2 are not connected (Phase F33).

Also in a case where the claw 61 is operated to enter the unlatched state other than a case where the connector 13 of the charging device according to the third embodiment is connected to the plug 22 of the electromotive vehicle 2, the charging device turns ON the first relay 11, and when confirming that the communication with the electromotive vehicle 2 is not performed, the charging device turns OFF the first relay 11 after the elapse of the predetermined time t3 (Phase F34). At that time, the charging device maintains the connection state between the charging device and the electromotive vehicle 2.

As described above, the charging device according to the third embodiment can detect the connection state between the charging device and the electromotive vehicle 2 even for the electromotive vehicle 2 that does not apply a voltage to the connector connection confirmation line 45. In addition, the charging device can start charging the storage battery 21 when the connector 13 of the charging device is connected to the electromotive vehicle 2.

Because the charging device according to the third embodiment does not maintain the state where the first relay 11 is being ON, it is possible to avoid a short circuit of the power supply 17 and corrosion of an electrode included in the charging device, for example, in a case where the connector 13 is submerged. As a result, the reliability of the charging device according to the third embodiment is high and the lifetime of the charging device according to the third embodiment is long as compared to those of the charging devices according to the first and second embodiments.

In each of the first to third embodiments, the charging device has been described. The charging device may be replaced with a charging/discharging device that charges/discharges the storage battery 21 of the electromotive vehicle 2. In that case, it is possible to use the charging/discharging device in order to manage the quantity of available storage batteries 21 on the basis of the connection state between the charging/discharging device and the electromotive vehicle 2 in the V2H system or the V2G system.

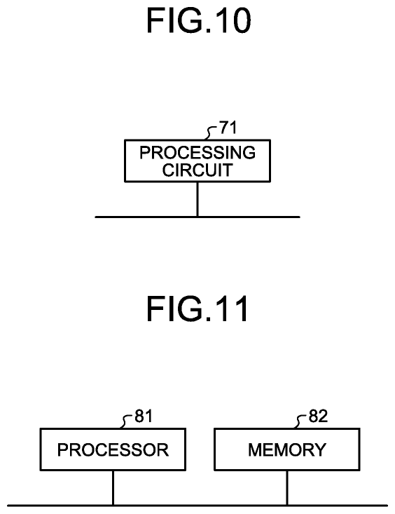

FIG. 10 is a diagram illustrating a processing circuit 71 when at least a part of components constituting the first relay 11 and the controller 15 included in the charging device 1 according to the first embodiment is realized by the processing circuit 71. That is, at least a part of functions of the first relay 11 and the controller 15 may be realized by the processing circuit 71.

The processing circuit 71 is dedicated hardware. The processing circuit 71 is, for example, a single circuit, a composite circuit, a programmed processor, a parallel programmed processor, an application specific integrated circuit (ASIC), a field-programmable gate array (FPGA), or a combination thereof. A part of the first relay 11 and the controller 15 may be dedicated hardware separate from the remainder.

FIG. 11 is a diagram illustrating a processor 81 when at least a part of the functions of the first relay 11 and the controller 15 included in the charging device 1 according to the first embodiment is realized by the processor 81. That is, at least a part of the functions of the first relay 11 and the controller 15 may be realized by the processor 81 executing programs stored in a memory 82.

The processor 81 is a central processing unit (CPU), a processing device, an arithmetic device, a microprocessor, a microcomputer, or a digital signal processor (DSP). FIG. 11 also illustrates the memory 82.

In the case where at least a part of the functions of the first relay 11 and the controller 15 is realized by the processor 81, the part of the functions is realized by a combination of the processor 81 and software, firmware, or software and firmware.

The software or the firmware is described as a program and stored in the memory 82. By reading and executing the programs stored in the memory 82, the processor 81 realizes at least a part of the functions of the first relay 11 and the controller 15.

When at least a part of the functions of the first relay 11 and the controller 15 is realized by the processor 81, the charging device 1 includes the memory 82 for storing programs with which steps executed by at least a part of the first relay 11 and the controller 15 are executed as a result. It can be said that the programs stored in the memory 82 cause a computer to execute a procedure or method executed by at least a part of the first relay 11 and the controller 15.

The memory 82 is a non-volatile or volatile semiconductor memory such as a random access memory (RAM), a read only memory (ROM), a flash memory, an erasable programmable read only memory (EPROM), or an electrically erasable programmable read only memory (EEPROM (registered trademark)); a magnetic disk; a flexible disk; an optical disk; a compact disc; a mini disk; a digital versatile disk (DVD); or the like.

Regarding a plurality of functions of the first relay 11 and the controller 15, a part of the functions may be realized by dedicated hardware and the remainder of the functions may be realized by software or firmware. Thus, the functions of the first relay 11 and the controller 15 can be realized by hardware, software, firmware, or a combination thereof.

At least a part of the functions of the first relay 11, the controller 15, and the claw state detector 62 included in the charging device according to the second embodiment may be realized by a processing circuit equivalent to the processing circuit 71.

At least a part of the functions of the first relay 11, the controller 15, and the claw state detector 62 included in the charging device according to the second embodiment may be realized by a processor equivalent to the processor 81. When the at least a part of the functions is realized by the processor, the charging device includes a memory for storing programs with which steps executed by at least a part of the first relay 11, the controller 15, and the claw state detector 62 are executed as a result. The memory is equivalent to the memory 82.

At least a part of the functions of the first relay 11, the controller 15, and the claw state detector 62 included in the charging device according to the third embodiment may be realized by a processing circuit equivalent to the processing circuit 71.

At least a part of the functions of the first relay 11, the controller 15, and the claw state detector 62 included in the charging device according to the third embodiment may be realized by a processor equivalent to the processor 81. When the at least a part of the functions is realized by the processor, the charging device includes a memory for storing programs with which steps executed by at least a part of the first relay 11, the controller 15, and the claw state detector 62 are executed as a result. The memory is equivalent to the memory 82.

The configurations described in the embodiments above are merely examples of the content of the present invention and can be combined with other known technology and part thereof can be omitted or modified without departing from the gist of the present invention.

### REFERENCE SIGNS LIST

1 charging device; 2 electromotive vehicle; 11 first relay; 12 housing; 13 connector; 14 cable; 15, 23 controller; 16 communication line; 17, 24 power supply; power line; 19 charge start/stop line; 21 storage battery; 22 plug; 25 vehicle contactor; 26 vehicle contactor drive relay; 27 first relay detector; 28 second relay detector; 29 connection detector; 30 charge/discharge permission prohibition output unit; 41 second relay; 42 charge permission prohibition input unit; first charge start/stop line; 44 second charge start/stop line; 45 connector connection confirmation line; 46 charge permission prohibition line; 47 ground line; 48 first communication line; 49 second communication line; 50 first power line; 51 second power line; 61 claw; 62 claw state detector; 71 processing circuit; 81 processor; 82 memory.

1.-10. (canceled)

11. A charging device that charges a storage battery of an electromotive vehicle, the charging device comprising:
a connector to be connected to a plug provided on the electromotive vehicle;
a first relay to generate a communication start signal for starting communication between the charging device and the electromotive vehicle;
a cable to electrically connect the charging device and the electromotive vehicle, the cable including the connector at one end thereof; and
a controller to control the first relay to be in a state of starting communication when the connector and the plug are not connected, and to, when the connector and the plug are connected in the state of starting communication, detect connection.

12. The charging device according to claim 11, wherein
the controller periodically controls the first relay from when the connector and the plug are connected up to when the connector and the plug are disconnected, and when detecting that the connector and the plug are disconnected, controls the first relay to be in the state of starting communication.

13. The charging device according to claim 11, wherein
the controller detects a connection state between the charging device and the electromotive vehicle by starting the communication.

14. The charging device according to claim 11, wherein
the controller performs control so that after communication between the charging device and the electromotive vehicle is started, the communication is continued and charging is performed.

15. The charging device according to claim 11, wherein
the controller performs control so that after communication between the charging device and the electromotive vehicle is started, the communication is ended and charging is not performed.

16. A charging device that charges a storage battery of an electromotive vehicle, the charging device comprising:
a connector to be connected to a plug provided on the electromotive vehicle;
a claw provided on the connector, the claw being buried until the connector is inserted into and fitted to the plug, and projecting when the connector is fitted to the plug to fix the connector and the plug;
a claw state detector provided on the connector to detect whether the claw is in a buried state or a projecting state;
a cable to electrically connect the charging device and the electromotive vehicle, the cable including the connector at one end thereof;
a first relay to generate a communication start signal for starting communication between the charging device and the electromotive vehicle; and
a controller to control the first relay to be in a state of starting communication when the claw state detector detects that the claw has changed from a buried state to a projecting state.

17. The charging device according to claim 16, wherein
the controller detects a connection state between the charging device and the electromotive vehicle by starting the communication.

18. The charging device according to claim 16, wherein
the controller performs control so that after communication between the charging device and the electromotive vehicle is started, the communication is continued and charging is performed.

19. The charging device according to claim 16, wherein
the controller performs control so that after communication between the charging device and the electromotive vehicle is started, the communication is ended and charging is not performed.

20. A charging/discharging device that charges and discharges a storage battery of an electromotive vehicle, the charging/discharging device comprising:
a connector to be connected to a plug provided on the electromotive vehicle;
a first relay to generate a communication start signal for starting communication between the charging/discharging device and the electromotive vehicle;
a cable to electrically connect the charging/discharging device and the electromotive vehicle, the cable including the connector at one end thereof; and
a controller to control the first relay to be in a state of starting communication when the connector and the plug are not connected, and to, when the connector and the plug are connected in the state of starting communication, detect connection.

21. The charging/discharging device according to claim 20, wherein
the controller periodically controls the first relay from when the connector and the plug are connected up to when the connector and the plug are disconnected, and when detecting that the connector and the plug are disconnected, controls the first relay to be in the state of starting communication.

22. The charging/discharging device according to claim 20, wherein
the controller detects a connection state between the charging/discharging device and the electromotive vehicle by starting the communication.

23. The charging/discharging device according to claim 20, wherein
the controller performs control so that after communication between the charging/discharging device and the electromotive vehicle is started, the communication is continued and charging and discharging are performed.

24. The charging/discharging device according to claim 20, wherein
the controller performs control so that after communication between the charging/discharging device and the electromotive vehicle is started, the communication is ended and charging and discharging are not performed.

25. A charging/discharging device that charges and discharges a storage battery of an electromotive vehicle, the charging/discharging device comprising:
a connector to be connected to a plug provided on the electromotive vehicle;
a claw provided on the connector, the claw being buried until the connector is inserted into and fitted to the plug, and projecting when the connector is fitted to the plug to fix the connector and the plug;
a claw state detector provided on the connector to detect whether the claw is in a buried state or a projecting state;
a cable to electrically connect the charging/discharging device and the electromotive vehicle, the cable including the connector at one end thereof;
a first relay to generate a communication start signal for starting communication between the charging/discharging device and the electromotive vehicle; and
a controller to control the first relay to be in a state of starting communication when the claw state detector detects that the claw has changed from a buried state to a projecting state.

26. The charging/discharging device according to claim 25, wherein
the controller detects a connection state between the charging/discharging device and the electromotive vehicle by starting the communication.

27. The charging/discharging device according to claim 25, wherein
the controller performs control so that after communication between the charging/discharging device and the electromotive vehicle is started, the communication is continued and charging and discharging are performed.

28. The charging/discharging device according to claim 25, wherein
the controller performs control so that after communication between the charging/discharging device and the electromotive vehicle is started, the communication is ended and charging and discharging are not performed.
